(19) United States
(12) Patent Application Publication
(10) Pub. No.: US 2026/0262098 A1
(43) Pub. Date: Sep. 3, 2026

(54) DETERMINING CONTENTION RESOLUTION

(71) Applicant: Nokia Technologies Oy, Espoo (FI)

(72) Inventors: Samuli Heikki Turtinen, Ii (FI); Chunli Wu, Beijing (CN); Matha Deghel, Montrouge (FR); Timo Koskela, Oulu (FI)

(21) Appl. No.: 19/163,309

(22) PCT Filed: Apr. 6, 2023
(86) PCT No.: PCT/CN2023/086703

§ 371 Date: Sep. 8, 2025

(51) Int. Cl. H04W 74/0833; H04W 72/1268; H04W 76/38

(52) U.S. Cl. CPC H04W 74/0833; H04W 72/1268; H04W 76/38

(57) ABSTRACT

Embodiments of the present disclosure relate to determining a contention resolution. In an aspect, a terminal device receives, as part of a random access (RA) procedure and after a message 3 (Msg3) transmission or a message A (MSGA) transmission, a physical downlink control channel (PDCCH) transmission in a serving cell, wherein the PDCCH transmission is addressed to an identifier of the terminal device and contains an uplink (UL) grant for a new transmission, and the serving cell is configured with multiple timing advance groups (TAGs). The terminal device determines the RA procedure or a contention resolution of the RA procedure as successful or unsuccessful based on an association between the UL grant and a TAG among the multiple TAGs. The embodiments of the present disclosure allow a contention resolution to be determined without knowing to which TAG or transmission and reception point (TRP) the physical random access channel (PRACH) preamble transmission applies to.

### FIELD

Various example embodiments generally relate to the field of communication, and in particular, to terminal devices, methods, apparatuses and a computer readable storage medium for determining a contention resolution.

### BACKGROUND

In New Radio (NR) systems, the concept and functionality of NR timing advance (TA) is substantially same as the long term evolution (LTE) timing advance. Briefly, TA is a special command (e.g. notification) from a network device to a terminal device that enables the terminal device to adjust its uplink transmission. This kind of uplink adjustment may apply to a physical uplink shared channel (PUSCH), a physical downlink Control Chanel (PDCCH), a sounding reference signal (SRS) and so on.

In 3GPP release18, it was agreed to support two-TA enhancement for uplink (UL) multi-downlink control information (DCI) for multi-Transmission and reception point (TRP) operation. However, solutions regarding multiple TAs need to be further studied.

### SUMMARY

In general, example embodiments of the present disclosure provide terminal devices, methods, apparatuses and a computer readable storage medium for determining a contention resolution. For example, the solution provided by the example embodiments of the present disclosure can allow a contention resolution to be determined without knowing to which timing advance group (TAG) or TRP the physical random access channel (PRACH) preamble transmission applies to.

In a first aspect, there is provided a terminal device. The terminal device may comprise at least one processor; and at least one memory storing instructions that, when executed by the at least one processor, cause the terminal device at least to: receive, as part of a random access (RA) procedure and after a message 3 (Msg3) transmission or a message A (MSGA) transmission, a PDCCH transmission in a serving cell, wherein the PDCCH transmission is addressed to an identifier of the terminal device and contains a UL grant for a new transmission, and the serving cell is configured with multiple TAGs; and determine the RA procedure or a contention resolution of the RA procedure as successful or unsuccessful based on an association between the UL grant and a TAG among the multiple TAGs.

In a second aspect, there is provided a terminal device. The terminal device may comprise at least one processor; and at least one memory storing instructions that, when executed by the at least one processor, cause the terminal device at least to: receive, as part of a random access (RA) procedure and after a Msg3 transmission or a MSGA transmission, a PDCCH transmission of in serving cell, wherein the PDCCH transmission is addressed to an identifier of the terminal device, the serving cell is configured with multiple TAGs, and a time alignment timer (TAT) among multiple TATs for the multiple TAGs is not running; and determine the RA procedure or a contention resolution of the RA procedure as successful based on (i) a received transport block (TB) is successfully decoded and (ii) a medium access control (MAC) protocol data unit (PDU) corresponding to the TB contains a predetermined MAC control element (CE).

In a third aspect, there is provided a method. The method may comprise: receiving, at a terminal device and from a network device, as part of a random access (RA) procedure and after a Msg3 transmission or a MSGA transmission, a PDCCH transmission in a serving cell, wherein the PDCCH transmission is addressed to an identifier of the terminal device and contains a UL grant for a new transmission, and the serving cell is configured with multiple TAGs; and determining, at the terminal device, the RA procedure or a contention resolution of the RA procedure as successful or unsuccessful based on an association between the UL grant and a TAG among the multiple TAGs.

In a fourth aspect, there is provided a method. The method may comprise: receiving, at a terminal device and from a network device, as part of a random access (RA) procedure and after a Msg3 transmission or a MSGA transmission, a PDCCH transmission in a serving cell, wherein the PDCCH transmission is addressed to an identifier of the terminal device, the serving cell is configured with multiple TAGs, and a TAT among multiple TATs for the multiple TAGs is not running; and determining, at the terminal device, the RA procedure or a contention resolution of the RA procedure as successful based on (i) a received TB is successfully decoded and (ii) a medium access control MAC PDU corresponding to the TB contains a predetermined MAC CE.

In a fifth aspect, there is provided an apparatus. The apparatus may comprise: means for receiving, at a terminal device, as part of a random access (RA) procedure and after a Msg3 transmission or a MSGA transmission, a PDCCH transmission in a serving cell, wherein the PDCCH transmission is addressed to an identifier of the terminal device and contains a UL grant for a new transmission, and the serving cell is configured with multiple TAGs and means for determining the RA procedure or a contention resolution of the RA procedure as successful or unsuccessful based on an association between the UL grant and a TAG among the multiple TAGs.

In a sixth aspect, there is provided an apparatus of. The apparatus may comprise: means for receiving, at a terminal device, as part of a random access (RA) procedure and after a Msg3 transmission or a MSGA transmission, a PDCCH transmission in a serving cell, wherein the PDCCH transmission is addressed to an identifier of the terminal device, the serving cell is configured with multiple TAGs, and a TAT among multiple TATs for the multiple TAGs is not running; and means for determining the RA procedure or a contention resolution of the RA procedure as successful based on (i) a received TB is successfully decoded and (ii) a medium access control MAC PDU corresponding to the TB contains a predetermined MAC CE.

In a seventh aspect, there is provided a non-transitory computer readable medium comprising program instructions for causing an apparatus to perform at least the method according to the third or fourth aspect.

In an eighth aspect, there is provided a computer program comprising instructions, which, when executed by an apparatus, cause the apparatus at least to: receive, as part of a random access (RA) procedure and after a Msg3 transmission or a MSGA transmission, a PDCCH transmission in a serving cell, wherein the PDCCH transmission is addressed to an identifier of the terminal device and contains a UL grant for a new transmission, and the serving cell is configured with multiple TAGs; and determine the RA procedure or a contention resolution of the RA procedure as successful or unsuccessful based on an association between the UL grant and a TAG among the multiple TAGs.

In a ninth aspect, there is provided a computer program comprising instructions, which, when executed by an apparatus, cause the apparatus at least to: receive, as part of a random access (RA) procedure and after a Msg3 transmission or a MSGA transmission, a PDCCH transmission in a serving cell, wherein the PDCCH transmission is addressed to an identifier of the terminal device, the serving cell is configured with multiple TAGs, and a TAT among multiple TATs for the multiple TAGs is not running; and determine the RA procedure or a contention resolution of the RA procedure as successful based on (i) a received TB is successfully decoded and (ii) a MAC PDU corresponding to the TB contains a predetermined MAC CE.

In a tenth aspect, there is provided a terminal device. The terminal device may comprise a receiving circuitry configured to receive, as part of a random access (RA) procedure and after a Msg3 transmission or a MSGA transmission, a PDCCH transmission in a serving cell, wherein the PDCCH transmission is addressed to an identifier of the terminal device and contains a UL grant for a new transmission, and the serving cell is configured with multiple TAGs; and a determining circuitry configured to determine the RA procedure or a contention resolution of the RA procedure as successful or unsuccessful based on an association between the UL grant and a TAG among the multiple TAGs.

In an eleventh aspect, there is provided a terminal device. The terminal device may comprise a receiving circuitry configured to receive, as part of a random access (RA) procedure and after a Msg3 transmission or a MSGA transmission, a PDCCH transmission in a serving cell, wherein the PDCCH transmission is addressed to an identifier of the terminal device, the serving cell is configured with multiple TAGs, and a TAT among multiple TATs for the multiple TAGs is not running; and a determining transmitting circuitry configured to determine the RA procedure or a contention resolution of the RA procedure as successful based on (i) a received TB is successfully decoded and (ii) a MAC PDU corresponding to the TB contains a predetermined MAC CE.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1 illustrates an example network environment in which example embodiments of the present disclosure may be implemented;

FIG. 2 illustrates an example signaling process for determining a contention resolution in accordance with some example embodiments of the present disclosure;

FIG. 3 illustrates another example signaling process for determining a contention resolution in accordance with some example embodiments of the present disclosure;

FIG. 4 illustrates an example flowchart of a method implemented at a terminal device in accordance with some example embodiments of the present disclosure;

FIG. 5 illustrates an example flowchart of a method implemented at a terminal device in accordance with some example embodiments of the present disclosure;

FIG. 6 illustrates an example simplified block diagram of a device that is suitable for implementing embodiments of the present disclosure; and

FIG. 7 illustrates an example block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which the present disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It may be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s) that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as long term evolution (LTE), LTE-advanced (LTE-A), wideband code division multiple access (WCDMA), high-speed packet access (HSPA), narrow band Internet of things (NB-IoT) and so on. Furthermore, the communications between a terminal device and a network device in the communication network may be performed according to any suitable generation communication protocols, including, but not limited to, the third generation (3G), the fourth generation (4G), 4.5G, the fifth generation (5G) communication protocols, and/or beyond. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a remote radio unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial, a relay node, an integrated access and backhaul (IAB) node, and/or industrial wireless networks, and the like. In the following description, the terms “terminal device”, “communication device”, “terminal”, “user equipment” and “UE” may be used interchangeably.

As used herein, the term “TRP” refers to a transmit-receive point having an antenna array (with one or more antenna elements) at the network side located at a specific geographical location, which may be used for transmitting and receiving signals to/from the terminal device. In embodiment of the present disclosure, a TRP may refer to Macro Cell, micro cell, an RRH, a relay, a femto node, a pico node, etc. Although some embodiments of the present disclosure are described with reference to two TRPs for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

As used herein, the term “resource”, “transmission resource”, “resource block”, “physical resource block” (PRB), “uplink (UL) resource” or “downlink (DL) resource” may refer to any resource for performing a communication, for example, a communication between a terminal device and a network device, such as a resource in time domain, a resource in frequency domain, a resource in space domain, a resource in code domain, a resource in a combination of more than one domain or any other resource enabling a communication, and the like. In the following, a resource in time domain (such as, a subframe) will be used as an example of a transmission resource for describing some example embodiments of the present disclosure. It is noted that example embodiments of the present disclosure are equally applicable to other resources in other domains.

As discussed above, TA is a special command (e.g. notification) from a network device to a terminal device that enables the terminal device to adjust its uplink transmission. TA is a special command (e.g. notification) from the network device to the terminal device that enables the terminal device to adjust its uplink transmission.

TA can be delivered to a terminal device through RAR or MAC CE. A TA loop can be used to maintain the TA to enable alignment of UL signals (transmitted from a terminal device) at a network node within a certain time resolution. In a random access procedure, the terminal device may receive an initial TA value (e.g., an absolute TA value) in a RAR message. The TA value may then be updated with a MAC CE containing a TAC indicating a relative TA value. In addition, the UE may also autonomously update the TA by initiatively request an updated TA value. These operations of maintain the TA is called as a TA loop. Usually, a TA loop may correspond to UL transmissions toward a given TRP. In addition, a TA loop may correspond to TA maintained within a TAG. Therefore, one TA loop may correspond to one TA and the number of TA loops may indicate the number of used TAs. Thus, in the present disclosure, a TA loop may refer to a TA implicitly.

A timing advance group (TAG) used herein means a group consists of one or more serving cells with the same uplink TA and same downlink timing reference cell. Each TAG contains at least one serving cell with configured uplink, and the mapping of each serving cell to a TAG is configured by a RRC signal. In 3GPP release 18, it was already agreed to support, in NR system, two TAs for UL multi-DCI for multi-TRP operation. In addition, the support of two TA enhancement has been agreed for both intra-cell and inter-cell multi-DCI multi-TRP scenarios in 3GPP release 18.

Release 18 work item on further new radio (NR) mobility enhancements is ongoing in 3GPP. The multiple (two) timing advance values for a UE within a serving cell will be further discussed in, for example, NR MIMO evolution WID (RP-223276), as shown in table 1.

TABLE 1

| | |
|---|---|
| 4 | Objective |
| 4.1 | Objective of SI or Core part WI or Testing part WI |

The detailed objectives are as follows:
RAN1:

| 1. | Study, and if justified, specify CSI reporting enhancement for high/medium UE velocities by | |
|---|---|---|
| | exploiting time-domain correlation/Doppler-domain information to assist DL precoding, | |
| | targeting FR1, as follows: | |
| | - | Rel-16/17 Type-II codebook refinement, without modification to the spatial and |
| | | frequency domain basis |
| | - | UE reporting of time-domain channel properties measured via CSI-RS for tracking |
| 2. | Specify extension of Rel-17 Unified TCI framework for indication of multiple DL and UL TCI | |
| | states focusing on multi-TRP use case, using Rel-17 unified TCI framework. | |
| 3. | Study, and if justified, specify larger number of orthogonal DMRS ports for downlink and | |
| | uplink MU-MIMO (without increasing the DM-RS overhead), only for CP-OFDM, | |
| | - | Striving for a common design between DL and UL DMRS |
| | - | Up to 24 orthogonal DM-RS ports, where for each applicable DMRS type, the maximum |
| | | number of orthogonal ports is doubled for both single- and double-symbol DMRS |
| 4. | Study, and if justified, specify enhancements of CSI acquisition for Coherent-JT targeting FR1 | |
| | and up to 4 TRPs, assuming ideal backhaul and synchronization as well as the same number of | |
| | antenna ports across TRPs, as follows: | |
| | - | Rel-16/17 Type-II codebook refinement for CJT mTRP targeting FDD and its associated |
| | | CSI reporting, taking into account throughput-overhead trade-off |
| | - | SRS enhancement to manage inter-TRP cross-SRS interference targeting TDD CJT via |
| | | SRS capacity enhancement and/or interference randomization, with the constraints that |
| | | 1) without consuming additional resources for SRS; 2) reuse existing SRS comb |
| | | structure; 3) without new SRS root sequences |
| | - | Note: the maximum number of CSI-RS ports per resource remains the same as in Rel-17, |
| | i.e. 32 | |
| 5. | Study, and if justified, specify UL DMRS, SRS, SRI, and TPMI (including codebook) | |
| | enhancements to enable 8 Tx UL operation to support 4 and more layers per UE in UL | |
| | targeting CPE/FWA/vehicle/Industrial devices | |
| | - | Note: Potential restrictions on the scope of this objective (including coherence |
| | | assumption, full/non-full power modes) will be identified as part of the study. |
| 6. | Study, and if needed, specify the following items to facilitate simultaneous multi-panel UL | |
| | transmission for higher UL throughput/reliability, focusing on FR2 and multi-TRP, assuming | |
| | up to 2 TRPs and up to 2 panels, targeting CPE/FWA/vehicle/industrial devices (if applicable) | |
| | - | UL precoding indication for PUSCH, where no new codebook is introduced for |
| | | multi-panel simultaneous transmission |
| | | • The total number of layers is up to four across all panels and total number of |

codewords is up to two across all panels, considering single DCI and multi-DCI
based multi-TRP operation.

| | |
|---|---|
| - | UL beam indication for PUCCH/PUSCH, where unified TCI framework extension in |
| | objective 2 is assumed, considering single DCI and multi-DCI based multi-TRP |
| | operation |

| | |
|---|---|
| • | For the case of multi-DCI based multi-TRP operation, only PUSCH+PUSCH, or |
| | PUCCH+PUCCH is transmitted across two panels in a same CC. |

| 7. | Study, and if justified, specify the following | |
|---|---|---|
| | - | Two TAs for UL multi-DCI for multi-TRP operation |
| | - | Power control for UL single DCI for multi-TRP operation where unified TCI framework |
| | | extension in objective 2 is assumed. |

For the case of simultaneous UL transmission from multiple panels, the operation will only be
limited to the objective 6 scenarios.

Further, MAC TS 38.321 specifies the contention resolution/successful RA procedure completion in RRC_CONNECTED mode as follows for 4-step RA and 2-step RA respectively, as shown in table 2.

TABLE 2

| | |
|---|---|
| 5.1.5 | Contention Resolution |

Once Msg3 is transmitted the MAC entity shall:

| | |
|---|---|
| 1> | if notification of a reception of a PDCCH transmission of the SpCell is received from lower |
| | layers: |

| | |
|---|---|
| 2> | if the C-RNTI MAC CE was included in Msg3: |

| | |
|---|---|
| 3> | if the Random Access procedure was initiated for SpCell beam failure recovery or for |
| | beam failure recovery of both BFD-RS sets of SpCell (as specified in clause 5.17) and |
| | the PDCCH transmission is addressed to the C-RNTI; or |
| 3> | if the Random Access procedure was initiated by a PDCCH order and the PDCCH |
| | transmission is addressed to the C-RNTI; or |
| | 3> if the Random Access procedure was initiated by the MAC sublayer itself or by the |
| | RRC sublayer and the PDCCH transmission is addressed to the C-RNTI and contains a |
| | UL grant for a new transmission: |

| | |
|---|---|
| 4> | consider this Contention Resolution successful; |
| 4> | stop ra-ContentionResolutionTimer; |
| 4> | discard the TEMPORARY_C-RNTI; |
| 4> | consider this Random Access procedure successfully completed. |

HARQ operation is not applicable to the Random Access Response reception.

| | |
|---|---|
| 5.1.4a | MSGB reception and contention resolution for 2-step RA type |

Once the MSGA preamble is transmitted, regardless of the possible occurrence of a measurement gap,
the MAC entity shall:

| | |
|---|---|
| 1> | start the msgB-ResponseWindow at the PDCCH occasion as specified in TS 38.213 [6], clause |
| | 8.2A; |
| 1> | monitor the PDCCH of the SpCell for a Random Access Response identified by MSGB-RNTI |
| | while the msgB-ResponseWindow is running; |
| 1> | if C-RNTI MAC CE was included in the MSGA: |

| | |
|---|---|
| 2> | monitor the PDCCH of the SpCell for Random Access Response identified by the C-RNTI |
| | while the msgB-ResponseWindow is running. |

| | |
|---|---|
| 1> | if notification of a reception of a PDCCH transmission of the SpCell is received from lower |
| | layers: |

| | |
|---|---|
| 2> | if the C-RNTI MAC CE was included in MSGA: |

| | |
|---|---|
| 3> | if the Random Access procedure was initiated for SpCell beam failure recovery or for |
| | beam failure recovery of both BFD-RS sets of SpCell (as specified in clause 5.17) and |
| | the PDCCH transmission is addressed to the C-RNTI: |

| | |
|---|---|
| 4> | consider this Random Access Response reception successful; |
| 4> | stop the msgB-ResponseWindow; |
| 4> | consider this Random Access procedure successfully completed. |

| | |
|---|---|
| 3> | else if the timeAlignmentTimer associated with the PTAG is running; or |
| 3> | if CG-SDT procedure is ongoing and cg-SDT-TimeAlignmentTimer is running: |

| | |
|---|---|
| 4> | if the PDCCH transmission is addressed to the C-RNTI and contains a UL grant for |
| | a new transmission: |

| | |
|---|---|
| 5> | consider this Random Access Response reception successful; |
| 5> | stop the msgB-ResponseWindow; |
| 5> | consider this Random Access procedure successfully completed. |

| | |
|---|---|
| 3> | else: |

| | |
|---|---|
| 4> | if a downlink assignment has been received on the PDCCH for the C-RNTI and the |
| | received TB is successfully decoded: |

| | |
|---|---|
| 5> | if the MAC PDU contains the Absolute Timing Advance Command MAC CE: |

| | |
|---|---|
| 6> | process the received Timing Advance Command (see clause 5.2); |
| 6> | consider this Random Access Response reception successful; |
| 6> | stop the msgB-ResponseWindow; |
| 6> | consider this Random Access procedure successfully completed and finish |
| | the disassembly and demultiplexing of the MAC PDU. |

Since in the multi-TRP scenario, the UE could have 2 TAGs for a serving cell (such as a special cell (SpCell, ie., either Primay Cell, PCell, or Primary Secondary Cell, PSCell)), these TAGS would naturally employ different TATs for the network to be able to provide separate timing adjustment commands using e.g., TAC MAC CE, and hence, the TATs may be started or restart in different times for these two TAGs.

Typically, in multi-TRP scenario within a serving cell, subset of the SSBs in the cell would be transmitted by one TRP and another subset of the SSBs by another TRP. When UE performs random access procedure, it selects one of these SSBs and, hence, may transmit the PRACH preamble to either one of the TRPs.

Therefore, when SpCell is configured with two TAGs, one of the TATs associated with these TAGS may not be running or has expired. Contention-based random access (CBRA) procedure may be triggered at any point in time for various reasons at the UE. For example, due to scheduling request (SR) when SR resources are not configured, number of SR transmissions reaches a configured threshold, beam failure recovery (BFR), or due to consistent listen-before-talk (LBT) failure detection. In this case, it is not clear how the UE should determine contention resolution to be successful and complete the random access procedure.

Example embodiments of the present disclosure provide a solution for determining a contention resolution. According to embodiments of the present disclosure, a terminal device receives, as part of a RA procedure and after a Msg3 transmission or a MSGA transmission, a PDCCH transmission in a serving cell, wherein the PDCCH transmission is addressed to an identifier of the terminal device and contains a UL grant for a new transmission, and the serving cell is configured with multiple TAGs. The terminal device determines the RA procedure or a contention resolution of the RA procedure as successful or unsuccessful based on an association between the UL grant and a TAG among the multiple TAGs. It is understood that the above procedure steps may work together, in a flow of operations as described in the next section, partly together or independently of each other.

The example embodiments for determining a RA procedure or a contention resolution of the RA procedure as provided in the present disclosure can allow a contention resolution to be determined without knowing to which TAG or TRP the PRACH preamble transmission applies to. Principles and some example embodiments of the present disclosure will be described in detail below with reference to the accompanying drawings.

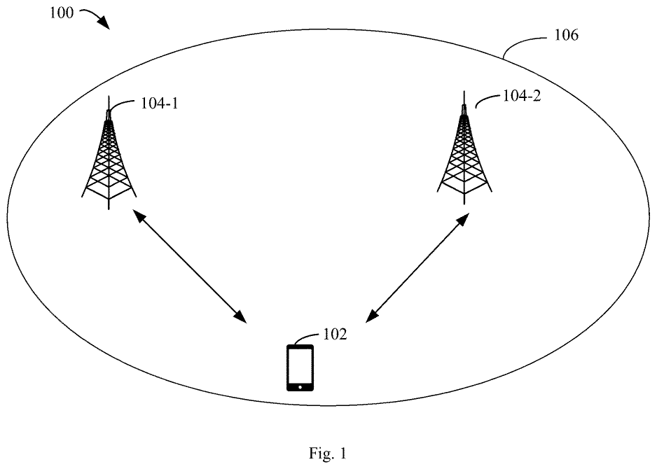

For illustrative purposes, principle and example embodiments of the present disclosure for determining resource blocks for transmissions will be described below with reference to FIG. 1-FIG. 7. However, it is to be noted that these embodiments are given to enable the skilled in the art to understand inventive concepts of the present disclosure and implement the solution as proposed herein, and not intended to limit scope of the present application in any way.

FIG. 1 illustrates an example of a communication network 100 in which some example embodiments of the present disclosure may be implemented. As illustrated in FIG. 1, the communication network 100 includes a terminal device (which may also be referred to as user equipment or UE) 102 and two network devices (which may also be referred to as a gNB or BS or TRP), such as the network devices 104-1 and 104-2 (can also be referred collectively as “network devices 104”). Although the terminal device 102 and two network devices 104 are shown in FIG. 1, the numbers of the network devices and the terminal devices are not limited. In other words, there may be one or more network devices 104 and one or more terminal devices 102 in the communication network 100.

The network device 104 can provide services to the terminal device 102, and the network device 104 and the terminal device 102 may communicate data and control information with each other. In some example embodiments, the network device 104 and the terminal device 102 may communicate with direct links/channels.

In the communication system 100, a link from the network device 104 to the terminal device 102 is referred to as a downlink (DL), while a link from the terminal device 102 to the network device 104 is referred to as an uplink (UL). In downlink, the network devices 104 are transmitting (TX) devices (or transmitters) and the terminal device 102 is a receiving (RX) device (or a receiver). In uplink, the terminal device 102 is a transmitting (TX) device (or a transmitter) and the network devices 104s are RX device (or receiver). It is to be understood that the network devices 104 may provide one or more serving cells. As illustrated in FIG. 1, the network devices 104 together provide a serving cell 106, and the terminal device 102 camps on the serving cell 106. In some embodiments, the network devices 104 can provide multiple serving cells and the terminal device 102 may switch from a source cell to a target cell between the serving cells during its mobility. It is to be understood that the number of serving cell(s) shown in FIG. 1 is for illustrative purposes without suggesting any limitation.

Communications in the network environment 100 may be implemented according to any proper communication protocol(s), comprising, but not limited to, cellular communication protocols of the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In some embodiments, the serving cell 106 may comprise a primary cell or a secondary cell with multiple network devices 104, such as TRPs. The network devices 104 may transmit different PDSCH but control signal (PDCCH/DCI) for the two PDSCH is transmitted by one of the network devices 104. In some embodiments, the network devices 104 may transmit two different PDSCH and each network device 104 transmits its own corresponding PDCCH/DCI. In some embodiments, the network devices may jointly transmit DL signals and receive UL signals.

As mentioned, the terminal device 102 may have two TAGs for the serving cell 106 and employ different TATs for one of more network devices to be able to provide separate TACs. The terminal device 102 may determine one of the TAGs is a primary TAG and the other is a secondary TAG. Upon expiry of one or more TATs, the terminal device 102 may keep one of the primary TAG and the secondary TAG. The network device 104 which provides the TAC is also aware of the TAT expiry. It knows which TAG is kept at the terminal device 102, and can act accordingly.

It is to be understood that the number of devices and their connection relationships and types shown in FIG. 1 are for illustrative purposes without suggesting any limitation. The communication system 100 may comprise any suitable number of devices adapted for implementing embodiments of the present disclosure.

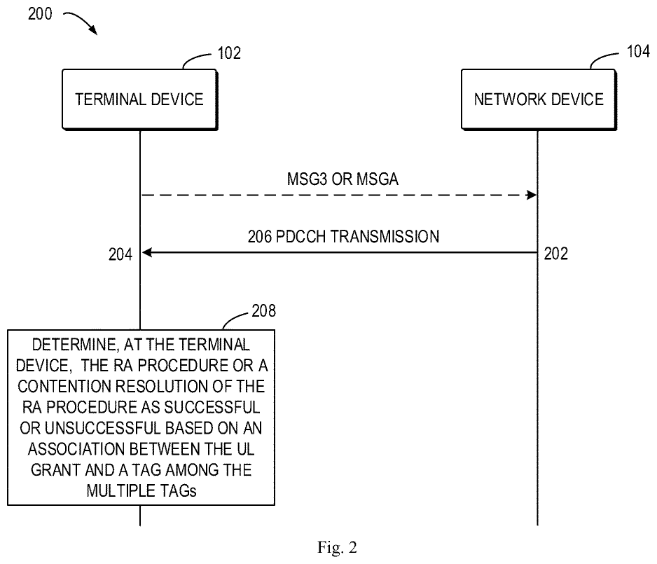

Reference is made to FIG. 2, which illustrates an example signaling process 200 for determining a contention resolution in accordance with some example embodiments of the present disclosure. As shown, after the terminal device 102 transmitted a Msg3 transmission or a MSGA transmission to the network device 104, the terminal device 102 receives (204) a PDCCH transmission (206) in a serving cell. The PDCCH transmission (206) is addressed to an identifier of the terminal device 102 and contains a UL grant for a new transmission. The serving cell may be configured with multiple TAGs. In some example embodiments, the network device 104 may transmit (202) the PDCCH transmission (206) to the terminal device 102.

As an example, a SpCell may be configured with two TAGs and CBRA procedure is triggered at the terminal device 102. For contention resolution and/or RA procedure completion after MSGA transmission for 2-step RA or after MSG3 transmission, if it is not indicated explicitly to the terminal device 102 to which TAG the TAC provided in RAR or fallbackRAR applies to, the terminal device 102 can perform a determining block 208. For example, the terminal device may not know or is not made to know by the network device 104 to which TAG the TAC provided in RAR of fallbackRAR applies to.

The terminal device 102 determines (208) a contention resolution and/or RA procedure as successful or unsuccessful based on an association between the UL grant and a TAG among the multiple TAGs. In some example embodiments, if one of the multiple TATs associated with the SpCell is not running or has expired, and the other one of the multiple TATs associated with the SpCell is running, the terminal device 102 may consider the contention resolution successful and/or RA procedure successfully completed in case the terminal device 102 receives the PDCCH transmission addressed to the C-RNTI which contains an UL grant for a new transmission and the UL grant is associated with the TAG for which the TAT is running. For example, the multiple TATs associated with the SpCell are associated with the multiple TAGs associated with the SpCell. For example, the multiple TATs may be associated with the SpCell by means of the multiple TAGs configured for the SpCell. For example, each TAT of the multiple TATs may be associated with a TAG of the multiple TAGs associated with/configured for the SpCell.

In some example embodiments, if one of the multiple TATs associated with the SpCell is not running or has expired, and the other one of the multiple TATs associated with the SpCell is running, the terminal device 102 may consider the RA procedure successfully completed in case the terminal device 102 receives the PDCCH transmission addressed to the C-RNTI which contains an UL grant for a new transmission and the UL grant is associated with the TAG for which the TAT is running. For example, when the RA procedure is considered successfully completed, contention resolution may be considered successful.

In some example embodiments, the terminal device 102 may determine the association between the UL grant and the TAG based on the CORESET scheduling the UL grant. For example, the TAG is associated with the CORESETpoolIndex value configured for the CORESET, and UL channels may be configured to be associated with a CORESETpoolindex.

In some example embodiments, the terminal device 102 may determine the association between the UL grant and the TAG based on indicated TCI state of the UL grant. For example, the indicated TCI state may be (unified) joint DL/UL TCI State or (unified) UL TCI State, or TCI state ID itself, or the SRS resource(s) used as reference for uplink transmission.

In some example embodiments, the terminal device 102 may determine the association between the UL grant and the TAG based on TAG ID associated with the TCI state indicated or configured for the UL transmission scheduled by the UL grant.

In some example embodiments, the terminal device 102 may determine the association between the UL grant and the TAG based on TAG ID corresponding to the PCI (physical cell ID) associated with the DL RS comprised in the TCI state indicated or configured for the UL transmission scheduled by the UL grant. In some example embodiments, the terminal device 102 may determine the association between the UL grant and the TAG based on indication in the UL grant.

In some example embodiments, if one of the multiple TATs associated with the SpCell is not running or has expired, as well as the other one of the multiple TATs associated with the SpCell is running, in case the terminal device 102 receives the PDCCH transmission addressed to the C-RNTI which contains an UL grant for a new transmission and the UL grant is associated with the TAG for which the TAT is not running, the terminal device 102 may apply the stored N_{TA} of the TAG as the UL timing. The terminal device 102 may start the TAT associated with the TAG. The terminal device 102 may consider contention resolution successful and/or RA procedure successfully completed.

In some example embodiments, the network device 104 may indicate in the DCI scheduling the UL grant if the terminal device 102 can apply the N_{TA} for the TAG with TAT not running. In some example embodiments, if network device 104 does not provide such indication, the terminal device 102 may consider the RA procedure not successfully completed.

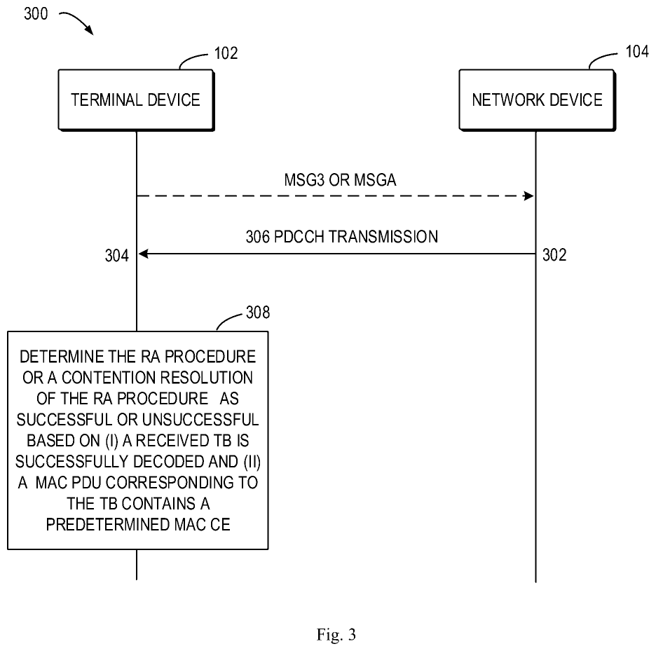

FIG. 3 illustrates another example signaling process 300 for determining a contention resolution in accordance with some example embodiments of the present disclosure. As shown, the terminal device 102 receives (304) a PDCCH transmission (306) in a serving cell as part of a RA procedure and after a Msg3 transmission or a MSGA transmission. The PDCCH transmission (306) is addressed to an identifier of the terminal device 102. The serving cell is configured with multiple TAGs, and a TAT among multiple TATs of the multiple TAGs is not running. In some example embodiments, the network device 104 may transmit (302) the PDCCH transmission (306) to the terminal device 102.

The terminal device 102 determines (208) a RA procedure or a contention resolution of the RA procedure as successful based on a received TB being successfully decoded and a MAC PDU corresponding to the TB containing a predetermined MAC CE. As an example, the MAC CE may be the Absolute TAC MAC CE. As another example, the MAC CE may be the Absolute TAC MAC CE and may indicate the TAG ID associated with the TAG for which TAT is not running.

In some example embodiments, the MAC CE may be a new empty MAC CE which contains only LCID or eLCID which indicates the terminal device 102 to apply or continue using the TAC received in a RAR for the TAG associated with the TAT that is not running. In some example embodiments, two LCIDs or eLCIDs may be specified which correspond to the different TAG IDs configured for the SpCell.

In some example embodiments, the terminal device 102 may apply the TAC received in a RAR or in the Absolute TAC MAC CE to the TAG for which the associated TAT is not running or has expired, and the terminal device 102 may start the TAT.

By implementing FIGS. 2 and 3, the example embodiments for determine a contention resolution can allow that a contention resolution can be determined without knowing to which TAG or TRP the PRACH preamble transmission applies to.

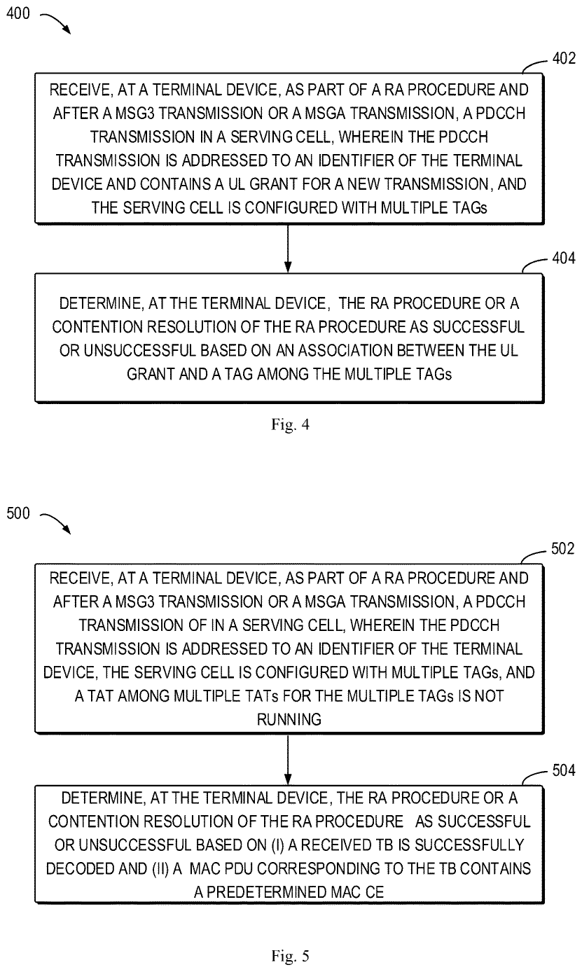

Reference is made to FIG. 4, which illustrates an example flowchart 400 of a method implemented at a terminal device in accordance with some example embodiments of the present disclosure. Reference will be made in combination with FIG. 1.

At 402, the terminal device 102 receives a PDCCH transmission in a serving cell as part of a RA procedure and after a Msg3 transmission or a MSGA transmission. The PDCCH transmission is addressed to an identifier of the terminal device 102 and contains a UL grant for a new transmission. The serving cell is configured with multiple TAGs. At 404, the terminal device 102 determines, based on an association between the UL grant and a TAG among the multiple TAGs, a contention resolution of the RA procedure as successful or unsuccessful, or the RA procedure successfully or unsuccessfully completed.

In some example embodiments, the terminal device 102 may determine the association between the UL grant and the TAG among the multiple TAGs based on a CORESET scheduling the UL grant. In some example embodiments, the terminal device 102 may determine the association between the UL grant and the TAG among the multiple TAGs based on an indicated TCI state of the UL grant. In some example embodiments, the terminal device 102 may determine the association between the UL grant and the TAG among the multiple TAGs based on a TAG ID associated with a TCI state indicated or configured for the UL transmission scheduled by the UL grant.

In some example embodiments, the terminal device 102 may determine the association between the UL grant and the TAG among the multiple TAGs based on a TAG ID corresponding to a PCI associated with a DL RS comprised in a TCI state indicated or configured for the UL transmission scheduled by the UL grant. In some example embodiments, the terminal device 102 may determine the association between the UL grant and the TAG among the multiple TAGs based on an indication in the UL grant.

In some example embodiments, the terminal device 102 may determine the contention resolution as successful or the RA procedure successfully completed by based on determining that a TAT for a TAG ID of the TAG associated with the UL grant is running. In some example embodiments, the terminal device 102 may determine the contention resolution as successful or the RA procedure successfully completed by based on determining that a TAT for a TAG ID of the TAG associated with the UL grant is not running. The terminal device 102 may apply a stored TA of a TAG with TAT not running as UL timing. The terminal device 102 may start the TAT.

In some example embodiments, the terminal device 102 may apply the stored TA of the TAG as UL timing by based on determining that DCI scheduling the UL grant indicates that the stored TA is applicable to the TAG ID of the TAG. The terminal device 102 may apply the stored TA of the TAG as the UL timing.

In some example embodiments, the terminal device 102 may determine the contention resolution as unsuccessful or the RA procedure successfully completed by based on determining that a DCI scheduling the UL grant does not indicate that a stored TA of a TAG with TAT not running is applicable to the TAG.

In some example embodiments, the terminal device 102 may receive, from the network device 104, a DCI indicating that the terminal device 102 is not allowed to apply the stored TA of the TAG. The terminal device 102 may determine the contention resolution unsuccessful.

Reference is made to FIG. 5, which illustrates another example flowchart 500 of a method implemented at a terminal device in accordance with some example embodiments of the present disclosure. Reference will be made in combination with FIG. 1.

At 502, the terminal device 102 receives a PDCCH transmission in a serving cell as part of a RA procedure and after a Msg3 transmission or a MSGA transmission. The PDCCH transmission is addressed to an identifier of the terminal device. The serving cell is configured with multiple TAGs, and a TAT among multiple TATs for the multiple TAGs is not running. At 504, the terminal device 102 determines a contention resolution as successful based on a received TB being successfully decoded and a MAC PDU corresponding to the TB containing a predetermined MAC CE.

In some example embodiments, the predetermined MAC CE may comprise an absolute TAC MAC CE. In some example embodiments, the predetermined MAC CE may comprise a TAC MAC CE and indicates that the TAG ID associated with a TAG with TAT among the multiple TATs which is not running. In some example embodiments, the predetermined MAC CE may be a new and empty MAC CE which contains a LCID or eLCID indicating the terminal device 102 to apply or continue using a TAC received in a RAR.

In some example embodiments, multiple LCIDs or eLCIDs are specified which correspond to the multiple TAG IDs configured for the serving cell. In some example embodiments, the terminal device 102 may apply the TAC received in a RAR or in an absolute TAC MAC CE to the TAG ID of the TAG for which the associated the TAT is not running. The terminal device 102 may start the TAT.

By implementing the methods 400 and/or 500, the example embodiments for determine a contention resolution can allow that a contention resolution can be determined without knowing to which TAG or TRP the PRACH preamble transmission applies to.

It is understood that the example embodiments of the present disclosure may be specified in TS 38.321, TS 38.212, TS 38.213, TS 38.300 as shown in tables 3-6. The texts underlined are to be specified.

TABLE 3

| | |
|---|---|
| 5.1.4a | MSGB reception and contention resolution for 2-step RA type |

Once the MSGA preamble is transmitted, regardless of the possible occurrence of a measurement gap,
the MAC entity shall:

| | |
|---|---|
| 1> | start the msgB-ResponseWindow at the PDCCH occasion as specified in TS 38.213 [6], clause |
| | 8.2A; |
| 1> | monitor the PDCCH of the SpCell for a Random Access Response identified by MSGB-RNTI |
| | while the msgB-ResponseWindow is running; |
| 1> | if C-RNTI MAC CE was included in the MSGA: |

| | |
|---|---|
| 2> | monitor the PDCCH of the SpCell for Random Access Response identified by the C-RNTI |
| | while the msgB-ResponseWindow is running. |

| | |
|---|---|
| 1> | if notification of a reception of a PDCCH transmission of the SpCell is received from lower |
| | layers: |

| | |
|---|---|
| 2> | if the C-RNTI MAC CE was included in MSGA: |

| | |
|---|---|
| 3> | if the Random Access procedure was initiated for SpCell beam failure recovery or for |
| | beam failure recovery of both BFD-RS sets of SpCell (as specified in clause 5.17) and |
| | the PDCCH transmission is addressed to the C-RNTI: |

| | |
|---|---|
| 4> | consider this Random Access Response reception successful; |
| 4> | stop the msgB-ResponseWindow; |
| 4> | consider this Random Access procedure successfully completed. |

| | |
|---|---|
| 3> | else if the timeAlignmentTimer associated with the PTAG is running; or |
| 3> | if CG-SDT procedure is ongoing and cg-SDT-TimeAlignmentTimer is running: |

| | |
|---|---|
| 4> | if the MAC entity is not configured with multiple TAGs for SpCell and if the PDCCH |
| | transmission is addressed to the C-RNTI and contains a UL grant for a new |
| | transmission; or |
| 4> | if the MAC entity is configured with multiple TAGs for SpCell and if the PDCCH |
| | transmission is addressed to the C-RNTI and contains a UL grant for a new |
| | transmission associated with the TAG and the associated timeAlignmentTimer is |
| | running: |

| | |
|---|---|
| 5> | consider this Random Access Response reception successful; |
| 5> | stop the msgB-ResponseWindow; |
| 5> | consider this Random Access procedure successfully completed. |

| | |
|---|---|
| 3> | else: |

| | |
|---|---|
| 4> | if a downlink assignment has been received on the PDCCH for the C-RNTI and the |
| | received TB is successfully decoded: |

| | |
|---|---|
| 5> | if the MAC PDU contains the Absolute Timing Advance Command MAC CE: |

| | |
|---|---|
| 6> | process the received Timing Advance Command (see clause 5.2); |
| 6> | consider this Random Access Response reception successful; |
| 6> | stop the msgB-ResponseWindow; |
| 6> | consider this Random Access procedure successfully completed and finish the |
| | disassembly and demultiplexing of the MAC PDU. |

TABLE 4

| | |
|---|---|
| 5.1.5 | Contention Resolution |

Once Msg3 is transmitted the MAC entity shall:

| | |
|---|---|
| 1> | if the Msg3 transmission (i.e. initial transmission or HARQ retransmission) is scheduled with |
| | Type A PUSCH repetition: |

| | |
|---|---|
| 2> | if Msg3 is transmitted on a non-terrestrial network: |

| | |
|---|---|
| 3> | start or restart the ra-ContentionResolutionTimer in the first symbol after the end of all |
| | repetitions of the Msg3 transmission plus the UE-gNB RTT. |

| | |
|---|---|
| 2> | else: |

| | |
|---|---|
| 3> | start or restart the ra-ContentionResolutionTimer in the first symbol after the end of all |
| | repetitions of the Msg3 transmission. |

| | |
|---|---|
| 1> | else if Msg3 transmission (i.e. initial transmission or HARQ retransmission) is transmitted on a |
| | non-terrestrial network: |

| | |
|---|---|
| 2> | start or restart the ra-ContentionResolutionTimer in the first symbol after the end of the |
| | Msg3 transmission plus the UE-gNB RTT. |

| | |
|---|---|
| 1> | else: |

| | |
|---|---|
| 2> | start or restart the ra-ContentionResolutionTimer in the first symbol after the end of the |
| | Msg3 transmission. |

| | |
|---|---|
| 1> | monitor the PDCCH while the ra-ContentionResolution Timer is running regardless of the |
| | possible occurrence of a measurement gap; |
| 1> | if notification of a reception of a PDCCH transmission of the SpCell is received from lower |
| | layers: |

| | |
|---|---|
| 2> | if the C-RNTI MAC CE was included in Msg3: |

| | |
|---|---|
| 3> | if the Random Access procedure was initiated for SpCell beam failure recovery or for |
| | beam failure recovery of both BFD-RS sets of SpCell (as specified in clause 5.17) and |
| | the PDCCH transmission is addressed to the C-RNTI; or |
| 3> | if the Random Access procedure was initiated by a PDCCH order and the PDCCH |
| | transmission is addressed to the C-RNTI; or |
| 3> | if the MAC entity is not configured with multiple TAGs for SpCell and if the Random |
| | Access procedure was initiated by the MAC sublayer itself or by the RRC sublayer and |
| | the PDCCH transmission is addressed to the C-RNTI and contains a UL grant for a new |
| | transmission; or |
| 3> | if the MAC entity is configured with multiple TAGs for SpCell and if the Random Access |
| | procedure was initiated by the MAC sublayer itself or by the RRC sublayer and the |
| | PDCCH transmission is addressed to the C-RNTI and contains a UL grant for a new |
| | transmission associated with the TAG and the associated time AlignmentTimer is running: |

| | |
|---|---|
| 4> | consider this Contention Resolution successful; |
| 4> | stop ra-ContentionResolutionTimer; |
| 4> | discard the TEMPORARY_C-RNTI; |
| 4> | consider this Random Access procedure successfully completed. |

TABLE 5

| | |
|---|---|
| 5.1.4a | MSGB reception and contention resolution for 2-step RA type |

Once the MSGA preamble is transmitted, regardless of the possible occurrence of a measurement gap,
the MAC entity shall:

| | |
|---|---|
| 1> | start the msgB-ResponseWindow at the PDCCH occasion as specified in TS 38.213 [6], clause |
| | 8.2A; |
| 1> | monitor the PDCCH of the SpCell for a Random Access Response identified by MSGB-RNTI |
| | while the msgB-ResponseWindow is running; |
| 1> | if C-RNTI MAC CE was included in the MSGA: |

| | |
|---|---|
| 2> | monitor the PDCCH of the SpCell for Random Access Response identified by the C-RNTI |
| | while the msgB-ResponseWindow is running. |

| | |
|---|---|
| 1> | if notification of a reception of a PDCCH transmission of the SpCell is received from lower |
| | layers: |

| | |
|---|---|
| 2> | if the C-RNTI MAC CE was included in MSGA: |

| | |
|---|---|
| 3> | if the Random Access procedure was initiated for SpCell beam failure recovery or for |
| | beam failure recovery of both BFD-RS sets of SpCell (as specified in clause 5.17) and |
| | the PDCCH transmission is addressed to the C-RNTI: |

| | |
|---|---|
| 4> | consider this Random Access Response reception successful; |
| 4> | stop the msgB-ResponseWindow; |
| 4> | consider this Random Access procedure successfully completed. |

| | |
|---|---|
| 3> | else if the timeAlignmentTimer associated with the PTAG is running; or |
| 3> | if CG-SDT procedure is ongoing and cg-SDT-TimeAlignmentTimer is running: |

| | |
|---|---|
| 4> | if the PDCCH transmission is addressed to the C-RNTI and contains a UL grant for a |
| | new transmission; or |
| 4> | (OPTIONAL) if the PDCCH transmission is addressed to the C-RNTI and contains a |
| | UL grant for a new transmission and indicates that the N_{TA} can be applied for the |
| | associated TAG: |

| | |
|---|---|
| 5> | consider this Random Access Response reception successful; |
| 5> | stop the msgB-ResponseWindow; |
| 5> | if the MAC entity is configured with multiple TAGs for SpCell and if the UL |
| | grant is associated with the TAG for which the associated timeAlignmentTimer is |
| | not running and if an N_{TA} (as defined in TS 38.211 [8]) has been maintained with |
| | the TAG: |

| | |
|---|---|
| 6> | apply the stored N_{TA} for the TAG; |
| 6> | start the timeAlignmentTimer associated with the TAG. |

| | |
|---|---|
| 5> | consider this Random Access procedure successfully completed. |

| | |
|---|---|
| 3> | else: |

| | |
|---|---|
| 4> | if a downlink assignment has been received on the PDCCH for the C-RNTI and the |
| | received TB is successfully decoded: |

| | |
|---|---|
| 5> | if the MAC PDU contains the Absolute Timing Advance Command MAC CE: |

| | |
|---|---|
| 6> | process the received Timing Advance Command (see clause 5.2); |
| 6> | consider this Random Access Response reception successful; |
| 6> | stop the msgB-Response Window; |
| 6> | consider this Random Access procedure successfully completed and finish the |
| | disassembly and demultiplexing of the MAC PDU. |

TABLE 6

| | |
|---|---|
| 5.1.5 | Contention Resolution |

Once Msg3 is transmitted the MAC entity shall:

| | |
|---|---|
| 1> | if the Msg3 transmission (i.e. initial transmission or HARQ retransmission) is scheduled with |
| | Type A PUSCH repetition: |

| | |
|---|---|
| 2> | if Msg3 is transmitted on a non-terrestrial network: |

| | |
|---|---|
| 3> | start or restart the ra-ContentionResolutionTimer in the first symbol after the end of all |
| | repetitions of the Msg3 transmission plus the UE-gNB RTT. |

| | |
|---|---|
| 2> | else: |

| | |
|---|---|
| 3> | start or restart the ra-ContentionResolutionTimer in the first symbol after the end of all |
| | repetitions of the Msg3 transmission. |

| | |
|---|---|
| 1> | else if Msg3 transmission (i.e. initial transmission or HARQ retransmission) is transmitted on |
| | a non-terrestrial network: |

| | |
|---|---|
| 2> | start or restart the ra-ContentionResolutionTimer in the first symbol after the end of the |
| | Msg3 transmission plus the UE-gNB RTT. |

| | |
|---|---|
| 1> | else: |

| | |
|---|---|
| 2> | start or restart the ra-ContentionResolutionTimer in the first symbol after the end of the |
| | Msg3 transmission. |

| | |
|---|---|
| 1> | monitor the PDCCH while the ra-ContentionResolutionTimer is running regardless of the |
| | possible occurrence of a measurement gap; |
| 1> | if notification of a reception of a PDCCH transmission of the SpCell is received from lower |
| | layers: |

| | |
|---|---|
| 2> | if the C-RNTI MAC CE was included in Msg3: |

| | |
|---|---|
| 3> | if the Random Access procedure was initiated for SpCell beam failure recovery or for |
| | beam failure recovery of both BFD-RS sets of SpCell (as specified in clause 5.17) and |
| | the PDCCH transmission is addressed to the C-RNTI; or |
| 3> | if the Random Access procedure was initiated by a PDCCH order and the PDCCH |
| | transmission is addressed to the C-RNTI; or |
| 3> | if the Random Access procedure was initiated by the MAC sublayer itself or by the |
| | RRC sublayer and the PDCCH transmission is addressed to the C-RNTI and contains a |
| | UL grant for a new transmission; or |
| 3> | (OPTIONAL) if the Random Access procedure was initiated by the MAC sublayer |
| | itself or by the RRC sublayer and the PDCCH transmission is addressed to the C-RNTI |
| | and contains a UL grant for a new transmission and indicates that the N_{TA} can be |
| | applied for the associated TAG: |

| | |
|---|---|
| 4> | consider this Contention Resolution successful; |
| 4> | stop ra-ContentionResolutionTimer; |
| 4> | discard the TEMPORARY_C-RNTI; |
| 4> | if the MAC entity is configured with multiple TAGs for SpCell and if the UL grant |
| | is associated with the TAG for which the associated time AlignmentTimer is not |
| | running and if an N_{TA} (as defined in TS 38.211 [8]) has been maintained with the |
| | TAG: |

| | |
|---|---|
| 5> | apply the stored N_{TA} for the TAG; |
| 5> | start the timeAlignmentTimer associated with the TAG. |

| | |
|---|---|
| 4> | consider this Random Access procedure successfully completed. |

In some example embodiments, an apparatus capable of performing the method 400 may comprise means for performing the respective steps of the method 400. The means may be implemented in any suitable form. For example, the means may be implemented in a circuitry or software module.

In some example embodiments, the apparatus may comprise means for receiving, as part of a RA procedure and after a Msg3 transmission or a MSGA transmission, a PDCCH transmission in a serving cell, wherein the PDCCH transmission is addressed to an identifier of the terminal device and contains a UL grant for a new transmission, and the serving cell is configured with multiple TAGs; and means for determining the RA procedure or a contention resolution of the RA procedure as successful or unsuccessful based on an association between the UL grant and a TAG among the multiple TAGs.

In some example embodiments, the apparatus may further comprise means for determining the association between the UL grant and the TAG among the multiple TAGs based on at least one of the following: a CORESET scheduling the UL grant; an indicated TCI state of the UL grant; a TAG associated with a TCI state indicated or configured for the UL transmission scheduled by the UL grant; a TAG corresponding to a PCI associated with a DL RS comprised in a TCI state indicated or configured for the UL transmission scheduled by the UL grant; or an indication in the UL grant.

In some example embodiments, the means for determining the contention resolution may further comprise means for determining the RA procedure or the contention resolution of the RA procedure as successful based on determining that a TAT for the TAG with a TAG ID associated with the UL grant is running.

In some example embodiments, the means for determining the contention resolution may further comprise means for determining the RA procedure or the contention resolution of the RA procedure as successful based on determining that a TAT for the TAG with a TAG ID associated with the UL grant is not running; means for applying a stored timing advance TA of a TAG with TAT not running as UL timing; and means for starting the TAT.

In some example embodiments, the means for applying a stored timing advance TA of a TAG with TAT not running as UL timing may further comprise means for applying the stored TA of the TAG as the UL timing based on determining that DCI scheduling the UL grant indicates that the stored TA is applicable to the TAG.

In some example embodiments, the means for determining the contention resolution may further comprise means for determining the RA procedure or the contention resolution of the RA procedure as unsuccessful based on determining that a DCI scheduling the UL grant does not indicate that a stored TA of a TAG with TAT not running is applicable to the TAG.

In some example embodiments, the apparatus may further comprise means for receiving, from a network device, a DCI indicating that the terminal device is not allowed to apply the stored TA of the TAG; and means for determining the contention resolution unsuccessful.

In some embodiments, the apparatus may further comprise means for performing other steps in some embodiments of the method 400. In some embodiments, the means comprises at least one processor and at least one memory including computer program code, the at least one memory and computer program code configured to, with the at least one processor, cause the performance of the apparatus.

In some example embodiments, an apparatus capable of performing the method 500 may comprise means for performing the respective steps of the method 500. The means may be implemented in any suitable form. For example, the means may be implemented in a circuitry or software module.

In some example embodiments, the apparatus may comprise means for receiving, as part of a random access (RA) procedure and after a Msg3 transmission or a MSGA transmission, a PDCCH transmission in a serving cell, wherein the PDCCH transmission is addressed to an identifier of the terminal device, the serving cell is configured with multiple TAGs, and a TAT among multiple TATs for the multiple TAGs is not running; and means for determining the RA procedure or the contention resolution of the RA procedure as successful based on (i) a received TB is successfully decoded and (ii) a MAC PDU corresponding to the TB contains a predetermined MAC CE.

In some example embodiments, the predetermined MAC CE may comprise an absolute TAC MAC CE. In some example embodiments, the predetermined MAC CE may comprise a TAC MAC CE and indicates that the TAG associated with a TAT among the multiple TATs which is not running.

In some example embodiments, the predetermined MAC CE may be a new and empty MAC CE which contains a LCID or eLCID indicating the terminal device to apply or continue using a TAC received in a RAR. In some example embodiments, multiple LCIDs or eLCIDs may be specified which correspond to the multiple TAG IDs configured for the serving cell.

In some example embodiments, the apparatus may comprise means for applying the TAC received in an RAR or in an absolute TAC MAC CE to the TAG ID of the TAG for which the associated the TAT is not running; and means for start the TAT.

In some embodiments, the apparatus may further comprise means for performing other steps in some embodiments of the method 500. In some embodiments, the means comprises at least one processor and at least one memory including computer program code, the at least one memory and computer program code configured to, with the at least one processor, cause the performance of the apparatus.

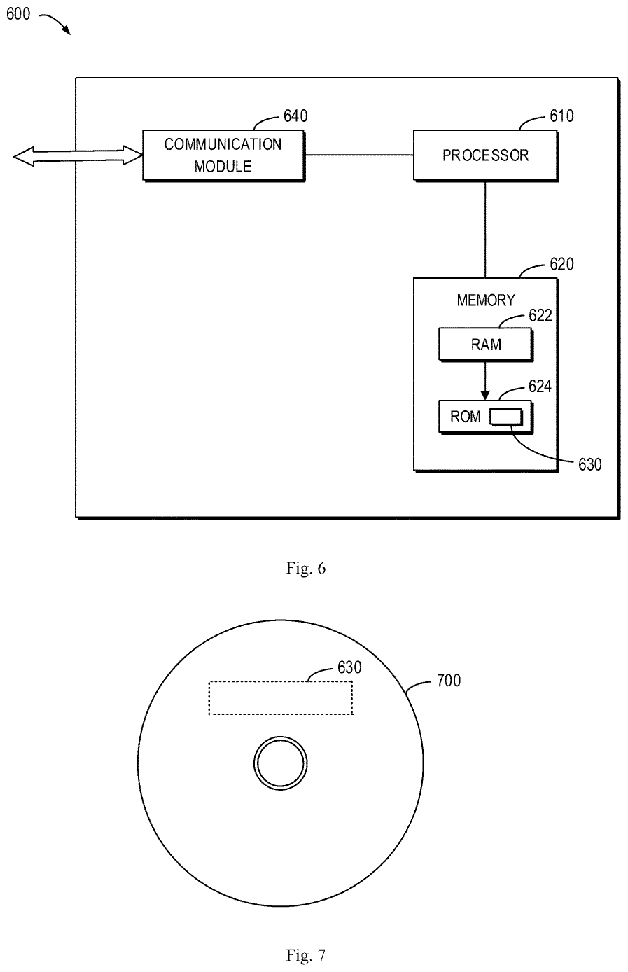

Reference is made to FIG. 6, which illustrates an example simplified block diagram of a device that is suitable for implementing embodiments of the present disclosure. The device 600 may be provided to implement the communication device, for example the terminal device 102 as shown in FIG. 1. As shown, the device 600 includes one or more processors 610, one or more memories 620 may couple to the processor 610, and one or more communication modules 640 may couple to the processor 610.

The communication module 640 is for bidirectional communications. The communication module 640 has at least one antenna to facilitate communication. The communication interface may represent any interface that is necessary for communication with other network elements, for example the communication interface may be wireless or wireline to other network elements, or software based interface for communication.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a read only memory (ROM) 624, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The program 630 may be stored in the ROM 624. The processor 610 may perform any suitable actions and processing by loading the program 630 into the RAM 622.

The embodiments of the present disclosure may be implemented by means of the program so that the device 600 may perform any process of the disclosure as discussed with reference to FIG. 2 to FIG. 5. The embodiments of the present disclosure may also be implemented by hardware or by a combination of software and hardware.

In some embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and the like. FIG. 7 shows an example of the computer readable medium 700 in form of CD or DVD. The computer readable medium has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 400 or 500 as described above with reference to FIG. 4 or FIG. 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. An apparatus comprising:
at least one processor; and
at least one memory coupled to the at least one processor and storing instructions that, when executed by the at least one processor, cause the apparatus at least to:
receive, as part of a random access (RA) procedure and after a message 3 (Msg3) transmission or a message A (MSGA) transmission, a physical downlink control channel (PDCCH) transmission in a serving cell, wherein the PDCCH transmission is addressed to an identifier of the apparatus and contains an uplink (UL) grant for a new transmission, and the serving cell is configured with multiple timing advance groups (TAGs); and
determine the RA procedure or a contention resolution of the RA procedure as successful or unsuccessful based on an association between the UL grant and a TAG among the multiple TAGs.

2. The apparatus of claim 1, wherein the apparatus is further caused to:
determine the association between the UL grant and the TAG among the multiple TAGs based on at least one of:
a control resource set (CORESET) scheduling the UL grant;
an indicated transmission configuration indication (TCI) state of the UL grant;
a TAG ID associated with a TCI state indicated or configured for the UL transmission scheduled by the UL grant;
a TAG ID corresponding to a physical cell identity (PCI) associated with a downlink (DL) reference signal (RS) comprised in a TCI state indicated or configured for the UL transmission scheduled by the UL grant; and
an indication in the UL grant.

3. The apparatus of claim 1, wherein the apparatus is caused to determine the RA procedure or the contention resolution as successful by:
based on determining that a time alignment timer (TAT) of the TAG associated with the UL grant is running, determining the RA procedure or the contention resolution as successful.

4. The apparatus of claim 1, wherein the apparatus is caused to determine the RA procedure or the contention resolution as successful by:
based on determining that a TAT of the TAG associated with the UL grant is not running, applying a stored timing advance (TA) of the TAG with TAT not running as UL timing;
starting the TAT; and
determining the RA procedure or the contention resolution as successful.

5. The apparatus of claim 4, wherein the apparatus is caused to apply the stored TA of the TAG as UL timing by:
based on determining that downlink control information (DCI) scheduling the UL grant indicates that the stored TA is applicable to the TAG, applying the stored TA of the TAG as the UL timing.

6. The apparatus of claim 1, wherein the apparatus is caused to determine the RA procedure or the contention resolution as unsuccessful by:
based on determining that a DCI scheduling the UL grant does not indicate that a stored TA of a TAG with TAT not running is applicable to the TAG, determining the RA procedure or the contention resolution as unsuccessful.

7. The apparatus of claim 4, wherein the apparatus is further caused to:
receive, from a network device, a downlink control information (DCI) indicating that the apparatus is not allowed to apply the stored TA of the TAG; and
determine the RA procedure or the contention resolution unsuccessful.

8. An apparatus comprising:
at least one processor; and
at least one memory coupled to the at least one processor and storing instructions that, when executed by the at least one processor, cause the apparatus at least to:
receive, as part of a random access (RA) procedure and after a message 3 (Msg3) transmission or a message A (MSGA) transmission, a physical downlink control channel (PDCCH) transmission in a serving cell, wherein the PDCCH transmission is addressed to an identifier of the apparatus, the serving cell is configured with multiple timing advance groups (TAGs), and a time alignment timer (TAT) among multiple TATs for the multiple TAGs is not running; and
determine the RA procedure or a contention resolution of the RA procedure as successful based on (i) a received transport block (TB) is successfully decoded and (ii) a medium access control (MAC) protocol data unit (PDU) corresponding to the TB contains a predetermined MAC control element (CE).

9. The apparatus of claim 8, wherein the predetermined MAC CE comprises:
an absolute timing advance command (TAC) MAC CE.

10. The apparatus of claim 8, wherein the predetermined MAC CE comprises a TAC MAC CE and indicates a TAG ID associated with a TAT among the multiple TATs which is not running.

11. The apparatus of claim 10, wherein the predetermined MAC CE is a new and empty MAC CE which contains a logical channel ID (LCID) or extended LCID (eLCID) indicating the apparatus to apply or continue using a TAC received in a random access response (RAR).

12. The apparatus of claim 11, wherein multiple LCIDs or eLCIDs are specified which correspond to the multiple TAG IDs configured for the serving cell.

13. The apparatus of claim 11, wherein the apparatus is further caused to:
apply the TAC received in an RAR or in an absolute TAC MAC CE to the TAG ID for which the associated the TAT is not running; and
start the TAT.

14. A method comprising:
receiving, at a terminal device and from a network device, as part of a random access (RA) procedure and after a message 3 (Msg3) transmission or a message A (MSGA) transmission, a physical downlink control channel (PDCCH) transmission in a serving cell, wherein the PDCCH transmission is addressed to an identifier of the terminal device and contains an uplink (UL) grant for a new transmission, and the serving cell is configured with multiple timing advance groups (TAGs); and
determining, at the terminal device, the RA procedure or a contention resolution of the RA procedure as successful or unsuccessful based on an association between the UL grant and a TAG among the multiple TAGs.

15. (canceled)

16. (canceled)
